(19) United States
(12) Patent Application Publication
(10) Pub. No.: US 2008/0091770 A1
(43) Pub. Date: Apr. 17, 2008

(54) Data transfer device for use with an intelligent electronic device (IED)

(75) Inventors: Charles E. Petras, Pullman, WA (US); Barron E. Barnett, Pullman, WA (US); Kenneth J. Fodero, Pullman, WA (US)

Correspondence Address: JENSEN + PUNTIGAM, P.S., SUITE 1020, 2033 6TH AVE, SEATTLE, WA, 98121, US

(73) Assignee: Schweitzer Engineering Laboratories, Inc., Pullman, WA (US)

(21) Appl. No.: 11/548,971

(22) Filed: Oct. 12, 2006

(51) Int. Cl. G06F 15/16

(52) U.S. Cl. 709/203

(57) ABSTRACT

The data transfer device is a hand-held device which includes a communication port and a port for accepting a rewriteable, removable memory card. The device further includes a microcontroller with an operating system capable of executing a file stored on the removable member card. The removable memory card is capable of receiving an executable file with a plurality of preprogrammed data transfer functions as well as storing data for transfer between the device and an IED. A user interface includes input members for accepting user instructions for selecting a data transfer function and a display for indicating the status of functions selected by the user.

### TECHNICAL FIELD

This invention relates generally to the art of transferring data to and from intelligent electronic devices (IEDs), and more specifically concerns a hand-held device for communicating with an IED, including transferring data to and from the IED.

### BACKGROUND OF THE INVENTION

Electric power systems incorporate various protection, control, automation and monitoring devices (IEDs) which typically have the capability of linking to an external computer to transmit data from the IEDs to the computer and to receive data from the computer. Data from an IED used for power system protection could include, for instance, sequence-of-event reports (SER) and relay-event reports (EVE), among others. Data provided to the IED from the computer could include, for instance, upgraded firmware, passwords permitting communication between the IED and the computer, new control settings, and communication tests. Many other applications, besides power systems, use IEDs and an external computer in similar fashion.

In current power system arrangements, a laptop computer is typically used to communicate with a power system IED, such as a protective relay. The laptop computer performs one or more of the above-described functions, e.g. transmitting passwords, downloading data, uploading upgraded firmware/software, providing new control settings, etc.

There are several well-known disadvantages to such an arrangement. First, a laptop computer is bulky and requires that the user be quite familiar with the overall functions and operation thereof, as well as the IED linked thereto. In many power system uses, a laptop computer, because of its size, is inconvenient, if not difficult, to use with IEDs in power substations and other IED locations. For example, if an IED needs an upgrade to its firmware, it would be necessary for an engineer to take the laptop physically to the device, plug it into the device, access the device by typing in a password on the laptop, finding the new firmware file in the laptop to transfer to the device, and then executing the transfer, installation and initialization of the upgraded firmware in the IED. The same process is often necessary when data is to be retrieved from an IED. A trained engineer is necessary to obtain the desired data in the correct format by use of a laptop computer.

Laptops or other similar computers contain significantly greater functionality than what is needed for typical data transfer to and from an IED, which may result in mistakes in use thereof, when attempted by personnel who are not highly computer trained. Errors for instances can occur in the uploading of new firmware for the IED and in retrieving desired data in the correct format from the IED.

It is hence desirable to have a data transfer device which is quite small, simple and straightforward to operate, with a minimum possibility for mistakes/misuse.

### SUMMARY OF THE INVENTION

Accordingly an embodiment disclosed herein is a hand-held data transfer and storage device for use with intelligent electronic devices (IEDs), comprising: a hand-held device assembly, including a communication port and a port for accepting a memory device; a microcontroller apparatus, part of the device assembly, including an operating system and adapted to execute a file present on the memory device; a memory device capable of receiving an executable file with a plurality of preprogrammed data transfer functions therein between the data transfer device and an IED and for storing data for transfer to and from an IED; and a user interface on the assembly for accepting user input, comprising a plurality of input members, for initiating the data transfer functions.

The hand-held data transfer device is also part of a data transfer system which includes an IED and a computer where data is transferred between the data transfer device and the IED and between the data transfer device and the computer.

### BRIEF DESCRIPTION OF THE DRAWINGS

FIG. 1 is a simplified block diagram showing an arrangement between the data transfer device disclosed herein, a representative IED, and a separate computer for configuring the data transfer device.

FIG. 2 is a diagram showing the structure of the data transfer device of FIG. 1.

### BEST MODE FOR CARRYING OUT THE INVENTION

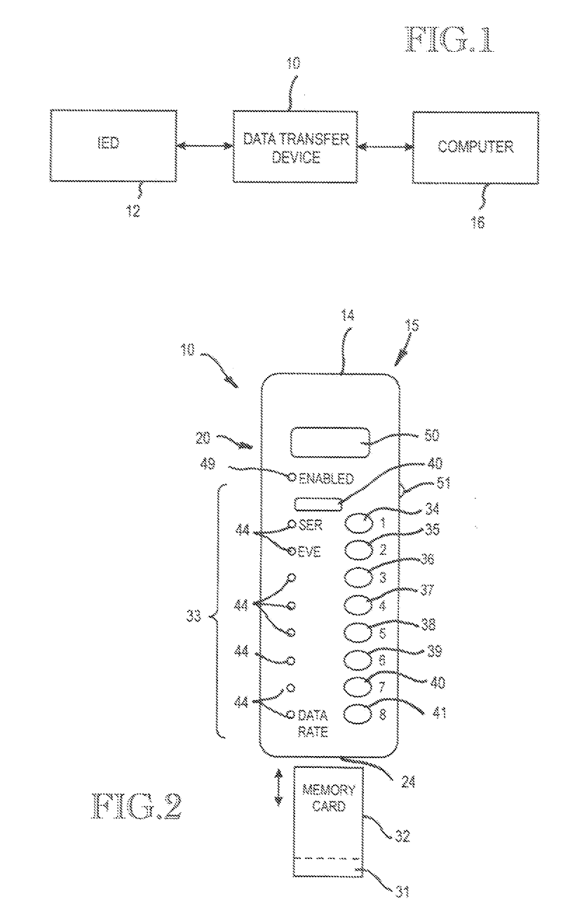

FIGS. 1 and 2 show the data transfer device of the present embodiment, generally at 10. The data transfer device 10 is functionally capable of communicating data to an intelligent electronic device (IED) 12 by means of a communication port, and also to receive data from the IED through that same port. Examples of data transferred from device 10 to the IED include upgraded firmware, and for an application involving electric power systems where the IED is a protective relay, control settings for the relay so that it operates in a particular pre-selected manner to protect a power system.

Examples of data transferred from the IED to the data transfer device include sequence of events data and relay event reports, which data can then be transferred in turn from the data transfer device 10 to an associated computer 16 for processing and analysis. The computer 16 is also used to configure the functionality of the data transfer device for a particular application, as discussed in detail below.

The IED portion of the system of FIG. 1 can be a variety of devices, including for example various protection, control, automation and monitoring devices used in an electric power system. Similar devices are used in other applications. The functionality of the data transfer device 10 can be adapted to perform the functions needed for a particular IED and a particular useful application.

FIG. 2 shows in more detail the data transfer device 10 of the present embodiment. The data transfer device includes a housing 20, which is approximately 2 inches long by 5.5 inches wide by 1.25 inches deep, configured so that it can be readily held in the hand of a user and is hence convenient to transport and use. The housing includes a communication port 14 at one end 15 thereof for communication with the IED or the computer. The device may include other communication ports adapted for other types of communication, for example, serial and parallel ports, fiber optic communication and RF and IR communication. In the embodiment shown, it is a EIA 232 device connector. At the other end of housing 20 is a slot 24 which is adapted to receive a memory card 32. The device 10 includes a microprocessor (microcontroller) with a simple operating system positioned within the housing 20. One example of a suitable microprocessor is Atmel ATmega 128.

The memory card 32 in the embodiment shown is a rewriteable, removable memory card which fits into slot 24. One example of a suitable card is a 128 MB SD (secure data) Memory card. The memory card has an executable file 31 stored thereon which is configured for preselected functionality by software in the computer 16 or by the factory.

The data transfer device also includes a user interface 33 which includes a plurality of interface input members 34-41, which in this case includes a total of eight numbered buttons, with each button having a particular functionality associated therewith. The executable file on the memory card includes a plurality of routines which run in response to operation of each of the user interface input members. Although the input members in the embodiment shown are in the form of user-operated buttons, any type of input member, including various switches and other touch elements, could be used.

The user interface further includes a plurality of LEDs 44, with one LED associated with each input member. The LEDs indicate the initiation/status of the functions associated with the individual input members.

On the face of the device is a slot 40 into which a function card may be inserted, on which is written the actual functions associated with the individual input members, so that the user knows which function will result when a particular input button is operated. The user interface 33 also includes an LCD screen 50 to display messages for the user, including the status of the various functions.

As referred to above, memory card 32 in use has an executable file 31 thereon which includes separate routines which are initiated when the user input buttons are operated, i.e. each routine is associated with a particular user input button. The executable file is typically written to the memory card by the action of configuration software present in the computer 16. The configuration software can be provided on the card by the factory and then read to the computer 16 which will then use the configuration software to write the executable file to the card. When the SD card file write function is completed, the device 10 is ready to be used.

As indicated above, there are various functions which include data transfer between device 10 and IED 12 with which it is linked. Besides operational data obtained by the IED in its normal operation, which is uploaded to the transfer device 10, and data such as firmware upgrades and passwords which are downloaded from the transfer device 10 to the IED 12, other specific functionality may be included on the memory card. Examples are the automatic determination of the baud rate of data transfer between the transfer device 10 and the IED 12, the use of a PIN number for actuation of the device and the input of a PIN by the user using buttons 34-41 in the required PIN sequence. While a PIN number may be required to operate the data transfer device, which thus must be known by the user-technician, a PIN number is not essential for the invention.

When a memory card with an executable file is inserted into the device 10 and the device is turned on via on/off switch 51, operation of the data transfer device is initiated. After an initialization routine, the data transfer device will energize the LED “Enabled” light 49 and the LCD display 50 will produce a prompt to enter the PIN code, which is preprogrammed into either then executable file or the microcontroller operating system. The PIN code will typically be encrypted.

After the correct PIN code is entered by the user, by operating the input members 34-41, the data transfer device 10 will then automatically detect and set its baud rate to match that of the IED connected thereto. The data rate will be displayed on the LCD display 50. Alternatively, the data rate can be set manually via the data rate button 41, at which point the associated LED 44 will light. A plurality of baud rates can be programmed into the device; examples include 38,400 BPS, 19,200 BPS, 9,600 BPS and 2,400 BPS. Other data rates are, of course, possible. The data transfer device 10 is now ready to execute any of the preprogrammed functions.

The executable file 31 on the memory card 32 contains a plurality of routines which run upon operation of the user input members. For example, the executable file 31 may include a routine which will result in a password being sent to the IED via the communication port 14 when button 36 is operated. After the password is sent, the associated LED or the LCD screen 50 will verify that the password has been sent. The executable file present on the card may also include a subroutine for displaying whether or not the transmitted password has been accepted by the IED.

Further, the executable file 31 on the memory card may include a routine which results in a command being sent to the IED to retrieve selected data available at the IED. When button 34 is operated, sequence-of-events data (SER) is transmitted from the IED to the device 10, while operation of button 35 will result in transmittal of relay even reports (EVE) from the IED to the device 10. Following retrieval of the data, the executable file 31 may also include a subroutine which directs the transfer device to store the retrieved data on the rewriteable, removable memory card and then to display an indication when this task has been completed.

As a further example, the executable file 31 may include a routine which sends a particular set of data from the rewriteable, removable memory, such as upgraded firmware, or in the case of a power system protective relay, new or modified settings, when another button, e.g. button 37, is operated.

Still further, the executable file 31 may include another specific routine which tests the communication between the IED and the data transfer device. This routine can be initiated when another button, e.g. button 39, is operated.

It should be understood that the above function examples are for illustration only. Various functions in addition to or as alternatives thereto which can be accomplished through the communication port of the device via an executable file on a memory card or similar device can be performed by the data transfer device.

Following the determination of the baud rate, the data transfer device 10 is ready to execute any of the preprogrammed functions by operating the associated user input member, e.g. button. When a button is operated, the LED 44 associated with that button will start to flash, indicating that the function is in progress. The LCD display 50 will also indicate the progress of the selected function from start to completion. Typically, the function LED will illuminate fully and the LCD will indicate completion when the function has in fact been completed.

The display 50 can also indicate various error messages, including an error in the selected function, low battery voltage or failure to detect the pressure of the memory card, as well as other messages.

In many cases, there will be a password which must be used to enable communication between the data transfer device and the IED. The IED password may be stored on the rewriteable, removable memory card and will typically be encrypted. The encrypted password may alternatively be stored in the operating system of the microcontroller of the device. When the password is to be sent to the IED to initiate data transfer, it is decrypted and when recognized by the IED, communication is enabled. This arrangement has the advantage that the technician operating the data transfer device does not need to know the password; only the PIN number for the data transfer device is necessary. This results in savings of time of an engineer who would otherwise be necessary to perform the data transfer task at the site of the IED.

As indicated above, the data transfer device is connectable to a separate computer, permitting data to be transferred from the data transfer device to the computer for analysis and processing, and also permitting the rewriteable, removable memory from the device to be configured with a particular executable file, as well as a directory for receipt of available data for transfer between IEDs.

Data may be transferred to the computer using the removable, rewriteable memory itself, after being obtained by the data transfer device. The rewriteable, removable memory may be removed from the data transfer device after the data transfer device has obtained data from an IED. The rewriteable, removable memory may then be placed in an appropriate port of the computer, which will then read the data from the rewriteable, removable memory, and may in addition write data to the rewriteable, removable memory, configure the rewriteable, removable memory, change the PIN number on the rewriteable, removable memory, change the password for the IED on the rewriteable, removable memory and the like.

In one embodiment, the rewriteable, removable memory may be configured at the factory with, for example, upgraded firmware for the IED. The rewriteable, removable memory may then be sent to the end user, who simply inserts the rewriteable, removable memory into the data transfer device, which proceeds to transfer the data, such as the upgraded firmware, to the IED as discussed above. Thus, firmware upgrades may be easily executed using the data transfer device.

Accordingly, a data transfer device has been described which is user convenient, permitting reliable and straightforward transfer of data between the device and an IED, with a minimal chance of error. A rewriteable, removable memory card can be programmed by a separate computer with an executable file to perform various preprogrammed functions associated with a single user input member.

Although a preferred embodiment of the invention has been disclosed for purposes of illustration, it should be understood that various changes, modifications and substitutions may be incorporated in the embodiment without departing from the spirit of the invention which is defined by the claims which follow.

What is claimed is:

1. A hand-held data transfer and storage device for use with intelligent electronic devices (IEDs), comprising:
a hand-held device assembly, including a communication port and a port for accepting a memory device;
a microcontroller apparatus, part of the device assembly, including an operating system and adapted to execute a file present on the memory device;
a memory device capable of receiving an executable file with a plurality of preprogrammed data transfer functions therein between the data transfer device and an IED and for storing data for transfer to and from an IED; and
a user interface on the assembly for accepting user input, comprising a plurality of input members, for initiating the data transfer functions.

2. The data transfer device of claim 1, wherein the memory device is a rewriteable, removable SD (secure data) memory card.

3. The data transfer device of claim 2, including a display for indicating status of one of the plurality of data transfer functions selected by the user by the input members.

4. The data transfer device of claim 3, further including a stored encrypted PIN number which must be entered before any of the data transfer functions can be executed.

5. The data transfer device of claim 1, wherein one of the plurality of data transfer functions comprises acceptance and/or storage of data from an IED.

6. The data transfer device of claim 1, wherein the IEDs are associated with electrical power protection systems.

7. The data transfer device of claim 1, wherein one of the plurality of data transfer functions comprises transfer of data from the data transfer device to the IED.

8. The data transfer device of claim 7, wherein the data includes at least one from a list consisting of firmware and operating settings for the IED.

9. The data transfer device of claim 1, further including an encrypted password for establishing communication with the IED.

10. The data transfer device of claim 1, including a visual indicator associated with each of the plurality of input members, indicating that a function associated with the input member has been initiated.

11. The data transfer device of claim 1, wherein the assembly includes a portion for accepting a member upon which can be written a function associated with each of the plurality of input members for inspection by a user.

12. The data transfer device of claim 1, wherein the plurality of input members comprise buttons operable by a user.

13. The data transfer device of claim 1, wherein one of the data transfer functions establishes a baud rate for data transfer between the data transfer device and the IED.

14. The data transfer device of claim 1, wherein the executable file on the memory device includes a baud-rate routine for automatically establishing a baud rate for data transfer between the device and the IED.

15. The data transfer device of claim 1, wherein the memory device is removable from the data transfer device and is adapted to be coupled communicatively with a computer for data transfer with the computer.

16. A system for data transfer and storage with an intelligent electronic device (IED), comprising:
an IED;
a hand-held device assembly, including a communication port and a port for accepting a memory device;
a microcontroller apparatus, part of the device assembly, including an operating system and adapted to execute a file present on the memory device;
a memory device capable of receiving an executable file with a plurality of preprogrammed data transfer functions therein between the data transfer device and an IED and for storing data for transfer to and from the IED;
a user interface on the assembly for accepting user input, comprising a plurality of input members, for initiating the data transfer functions; and
a computer for communicating with the data transfer device.

17. The system of claim 16, wherein the IED is for use with electric power systems.

18. The system of claim 16, wherein data is transferred between the data transfer devices and the computer.

19. The system of claim 18, wherein the data transferred to the data transfer device from the computer include at least one of firmware control settings and passwords for the IED.

20. The system of claim 16, wherein the computer includes a software program for providing the memory device with the executable file.

21. The system of claim 16, wherein the memory device is a rewriteable, removable SD (secure data) memory card.

22. The system of claim 16, wherein the memory device is removable from the data transfer device and is adapted to be coupled communicatively with the computer for data transfer with the computer.
